(19) United States
(12) Patent Application Publication
(10) Pub. No.: US 2007/0284198 A1
(43) Pub. Date: Dec. 13, 2007

(54) Disc brake, in particular for a utility vehicle

(75) Inventor: Borislav Salapic, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: KNORR-BREMSE SYSTEME FUER NUTZFAHRZEUGE GMBH, Muenchen (DE)

(21) Appl. No.: 11/798,912

(22) Filed: May 17, 2007

Related U.S. Application Data
(63) Continuation of application No. PCT/EP05/11978, filed on Nov. 9, 2005.

(30) Foreign Application Priority Data
Nov. 17, 2004 (DE) 10 2004 055 527.3

(51) Int. Cl. F16D 65/18; F16D 65/14

(52) U.S. Cl. 188/73.45

(57) ABSTRACT

A brake disc, in particular for a utility vehicle, includes a brake caliper which overlaps or engages with a brake disc at least in a peripheral area and which is secured to a brake carrier by fastening elements. Each fastening element includes a guide sleeve which is mounted in a bearing point of the brake caliper and which is screwed via a threaded shaft in the brake carrier and which can be displaced in an axial manner on the brake caliper, in relation to the brake disc. A longitudinal axis of the threaded shaft, which is screwed into the brake carrier, extends in a parallel manner and at a distance from the longitudinal axis of the bearing point of the brake caliper.

### CROSS-REFERENCE TO RELATED APPLICATIONS

This application is a continuation of PCT International Application No. PCT/EP2005/011978, filed on Nov. 9, 2005, which claims priority under 35 U.S.C. §119 to German Application No. 10 2004 055 527.3, filed Nov. 17, 2004, the entire disclosures of which are expressly incorporated by reference herein.

### BACKGROUND AND SUMMARY OF THE INVENTION

The present invention relates to a disc brake, in particular for a utility or commercial vehicle.

Known disc brakes for utility or commercial vehicles include a caliper, which straddles a brake disc at least in one circumferential edge region and is fastened to a brake carrier by fastening elements. Each fastening element has a guide spar, which is mounted in a bearing point of the caliper, is screwed into the brake carrier by way of a threaded shaft, and on which the caliper is displaceable axially in relation to the brake disc.

In disc brakes of this “sliding” type, the caliper is connected by fastening elements to the brake carrier, which is connected to the vehicle.

Here, guide spars are screwed into the brake carrier, which guide spars are guided at the other end in bearing points of the caliper, which are configured as sliding bearings, in such a way that axial displacement of the caliper with respect to the stationary brake carrier is possible. One of the sliding bearings is usually configured as a locating bearing with a minimal amount of sliding play, while the other acts as a floating bearing, as a result of which manufacturing tolerances, in particular, may be compensated.

The friction forces occurring during application of the brake, that is, when the brake linings are pressed against the brake disc, generate a torque which acts on the caliper and is transferred to the guide spar via the bearing point. Here, in particular, the threaded shaft is subjected to a tensile load, which results in a series of problems.

In order to absorb the loading which occurs, the threaded shaft has to have correspondingly large dimensions. This, naturally, requires a corresponding amount of available space, which is contrary to present requirements for minimizing the overall dimensions, in order to achieve smaller overall designs that may fit within the limited amount of wheel “envelope” space.

With previously known solutions, these requirements can be realized only with a reduction in the cross section, for example, of the screw shaft, as a result of which the loadability of the fastening elements naturally decreases. In such cases, there is the risk of the screw shaft breaking, which is not acceptable, in particular, in terms of safety. Moreover, the service life of the disc brake is naturally limited, which results in considerable economic disadvantages.

The present invention is, therefore, based on the need for a disc brake of the above-described type, in which the loadability of the fastening elements is optimized.

This need is met by a disc brake for a utility or commercial vehicle having a caliper, which straddles a brake disc at least in one circumferential edge region and is fastened to a brake carrier by fastening elements. Each fastening element has a guide spar, which is mounted in a bearing point of the caliper, is screwed into the brake carrier by way of a threaded shaft, and on which the caliper is displaceable axially in relation to the brake disc. The longitudinal axis of the threaded shaft, which is screwed onto the brake carrier, extends parallel to, and at a spacing from, the longitudinal axis of the bearing point of the caliper.

As a result of this structural refinement, the active lever arm, which determines the torque, is extended as it were, with the result that the force acting on the threaded shaft is reduced.

As a result, the cross section of the threaded shaft can be minimized, without a restriction on the loadability.

Preferably, the axis of the screw shaft is at a spacing from the axis of the bearing point toward the imaginary center of the caliper, or toward the imaginary outside, if the rotational direction is reversed.

The present invention achieves, as it were, an increase in the reaction force of the screw shaft and the brake is thus optimized overall; this is irrespective of the coefficient of friction of the friction pair brake lining/brake disc.

According to one advantageous embodiment of the invention, there is provision for the guide spar to be configured as a guide sleeve and a screw guided in the sleeve. The screw is screwed into the brake carrier as threaded shaft by way of its shaft end.

Here, the receptacle hole of the guide sleeve for the inserted screw is provided eccentrically, that is, the center axis of the insertion hole is otherwise at a spacing from the center axis of the guide sleeve.

This structural development of the invention permits extremely inexpensive manufacture and assembly of the guide spar, which forms one structural unit, the guide sleeve being of cylindrical configuration as an element.

In this embodiment, the assembly is simplified above all because the screw may be rotated into the guide sleeve which lies in the bearing point, without the guide sleeve itself co-rotating.

In order to hold the eccentricity in the predefined position, it is appropriate to arrange the guide sleeve in the bearing point such that it cannot rotate and, moreover, to position it accurately. For this purpose, the guide sleeve and the bearing point can be configured accordingly in structural terms.

The orientation of the two axes, that is to say in this case the center axis of the guide sleeve on one side and the center axis of the screw (or of the insertion opening), transversely with respect to the longitudinal extent, is adapted to the requirements. It is possible for the spacing plane between the two center axes to extend radially upward or downward (or to be oriented toward the further fastening element of the same side), with the result that the spacing planes of the two fastening elements lie in one common plane.

Further advantageous refinements of the invention are described herein.

Other objects, advantages and novel features of the present invention will become apparent from the following detailed description of the invention when considered in conjunction with the accompanying drawings.

### BRIEF DESCRIPTION OF THE DRAWINGS

FIG. 1 is a partially sectioned plan view of a disc brake according to the invention; and

FIG. 2 is a detailed sectioned plan view of the disc brake according to the invention.

### DETAILED DESCRIPTION OF THE DRAWINGS

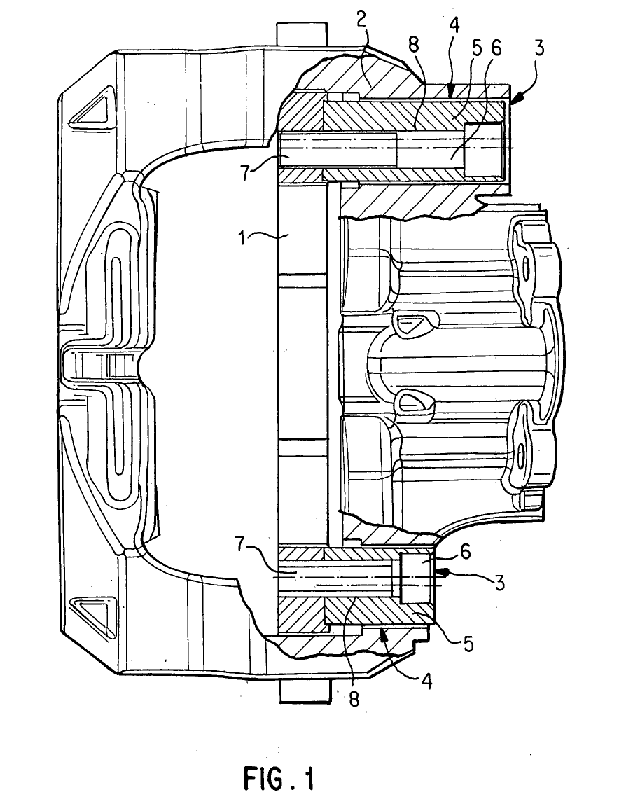

FIG. 1 shows a disc brake, in particular for a utility or commercial vehicle, which has a brake caliper 2 that engages around or straddles a brake disc (not shown) at least in one circumferential edge region thereof.

The caliper 2 is fastened by fastening elements 3 to a brake carrier 1 which, in the assembled position, is connected in a stationary manner to the vehicle.

The fastening elements 3 are configured, for example, as floating or locating bearings and, in each case, include a guide sleeve 5 and a screw (bolt) 6, the threaded shaft of which is screwed at least partially into the brake carrier 1. Here, the structural unit formed by the guide sleeve 5 and screw 6 forms a guide spar, on which the caliper 2 is mounted such that it can be displaced axially, for which purpose the caliper 2 has a bearing point 4, preferably as a sliding bearing.

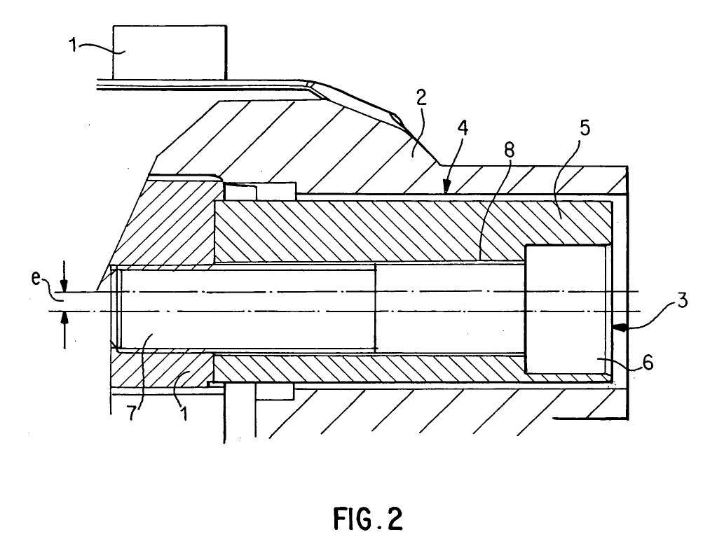

FIG. 2 is an enlarged illustration of the upper fastening element 3 in FIG. 1. FIG. 2 shows, in particular, that the guide sleeve 5 is provided with an insertion hole 8, into which the screw 6 is inserted. The insertion hole 8 is arranged eccentrically with respect to a center axis of the otherwise cylindrical guide sleeve 5, with the result that the inserted screw extends with its longitudinal axis at a spacing from the center axis of the guide sleeve 5. At the same time, the center axis of the guide sleeve 5 is the center axis of the bearing point 4. This spacing is labeled e in FIG. 2.

Here, as is apparent, in particular, from FIG. 1, the axes of the two screws 6 are displaced at a spacing from the axis of the bearing point 4 or the guide sleeve 5, in each case in a direction toward the center of the caliper 2. The

magnitude of the spacing e is defined by the cross-sectional dimension of the guide sleeve 5 or the prevailing space conditions.

In principle, the invention is not restricted to the exemplary embodiment which is shown, but may also be used in a disc brake having two locating bearings and only one floating bearing, or having one locating bearing and two floating bearings.

### TABLE OF REFERENCE SYMBOLS

1 Brake carrier
2 Caliper
3 Fastening element
4 Bearing point
5 Guide sleeve
6 Screw
7 Threaded shaft
8 Insertion hole

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A disc brake for a utility vehicle, comprising:
a brake disc;
a caliper which straddles the brake disc at least in a circumferential edge region when in use;
a brake carrier;
fastening elements which fasten the caliper to the brake carrier, each fastening element having a guide spar mounted in a bearing point of the caliper, the guide spar being screwed into the brake carrier via a threaded shaft and on which the caliper is axially displaceable relative to the brake disc; and
wherein a longitudinal axis of the threaded shaft screwed into the brake carrier extends parallel to, and spaced apart from, a longitudinal axis of the bearing point of the caliper.

2. The disc brake according to claim 1, wherein the longitudinal axis of the threaded shaft is at a spacing from the longitudinal axis of the bearing point in a direction toward a center axis of the caliper.

3. The disc brake according to claim 1, wherein the longitudinal axes of all bearing points on at least one side of the caliper are arranged in a common plane together with the longitudinal axes of the associated threaded shafts.

4. The disc brake according to claim 2, wherein the longitudinal axes of all bearing points on at least one side of the caliper are arranged in a common plane together with the longitudinal axes of the associated threaded shafts.

5. The disc brake according to claim 1, wherein the guide spar comprises a guide sleeve and a screw, which screw has the threaded shaft screwed into the brake carrier.

6. The disc brake according to claim 2, wherein the guide spar comprises a guide sleeve and a screw, which screw has the threaded shaft screwed into the brake carrier.

7. The disc brake according to claim 3, wherein the guide spar comprises a guide sleeve and a screw, which screw has the threaded shaft screwed into the brake carrier.

8. The disc brake according to claim 5, wherein the screw is inserted into an insertion hole of the guide sleeve, which insertion hole is arranged eccentrically with respect to a center axis of the guide sleeve, which guide sleeve has a cylindrical cross-section.

9. The disc brake according to claim 5, wherein the guide sleeve is operably configured such that it is substantially non-rotatable with respect to the bearing point.

10. The disc brake according to claim 8, wherein the guide sleeve is operably configured such that it is substantially non-rotatable with respect to the bearing point.

11. The disc brake according to claim 5, wherein the guide sleeve is held in a pre-defined position with respect to the bearing point.

12. The disc brake according to claim 8, wherein the guide sleeve is held in a pre-defined position with respect to the bearing point.

13. The disc brake according to claim 9, wherein the guide sleeve is held in a pre-defined position with respect to the bearing point.
